(19) United States
(12) Patent Application Publication
(10) Pub. No.: US 2021/0157768 A1
(43) Pub. Date: May 27, 2021

(54) Modify Content Management Rules Based on Sentiment

(71) Applicant: INTERNATIONAL BUSINESS MACHINES CORPORATION, ARMONK, NY (US)

(72) Inventors: Zachary A. Silverstein, Jacksonville, FL (US); Trudy L. Hewitt, Cary, NC (US); Robert Huntington Grant, Marietta, GA (US); Jeremy R. Fox, Georgetown, TX (US)

(21) Appl. No.: 16/696,380

(22) Filed: Nov. 26, 2019

(51) Int. Cl. G06F 16/11; G06N 3/08; G06F 16/9035

(52) U.S. Cl. CPC G06F 16/113; G06F 16/9035; G06N 3/08

(57) ABSTRACT

A computer receives an artifact. The computer determines a relationship of the artifact to a user. The computer analyzes the artifact to determine sentimental characteristics, responses of the user to the artifact and determines a sentimentality score based on the relationship, the sentimental characteristics and the response. Then, based on determining that the sentimentality score is above a threshold value, the computer triggers an archiving policy.

### BACKGROUND

The present invention relates, generally, to the field of computing, and more particularly to digital content management.

Any computing device stores personal artifacts that include, but not limited to multimedia (video, photos, graphics, etc.) and communications (audio, text, email, etc). These artifacts may have an extreme value for a user. The user may unintentionally remove the artifacts, especially either due to migration to a new device, automatic maintenance of the computing device, due to maintaining multiple relationships or when the user is deleting the artifact due to a mental or elderly state. Furthermore, these artifacts may be deleted automatically during archiving, deleting or routine maintenance of the mobile or computing device.

### SUMMARY

According to one embodiment, a method, computer system, and computer program product for sentiment-based content management is provided. The present invention may include a computer receives an artifact. The computer determines a relationship of the artifact to a user. The computer analyzes the artifact to determine sentimental characteristics, responses of the user to the artifact and determines a sentimentality score based on the relationship, the sentimental characteristics and the response. Then, based on determining that the sentimentality score is above a threshold value, the computer triggers an archiving policy.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a sentiment-based content management process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to digital content management. The following described exemplary embodiments provide a system, method, and program product to, among other things, manage content of artifacts stored on a computing device by determining user sentiments towards each artifact and imposing archiving policy based on the sentiments. Therefore, the present embodiment has the capacity to improve the technical field of digital content management by archiving sentimental artifacts and avoiding their unintentional deletion.

As previously described, any computing device stores personal artifacts that include, but not limited to multimedia (video, photos, graphics, etc.) and communications (audio, text, email, etc). These artifacts may have an extreme value for a user. The user may unintentionally remove the artifacts, especially either due to migration to a new device, automatic maintenance of the computing device, due to maintaining multiple relationships or when the user is deleting the artifact due to a mental or elderly state. Furthermore, these artifacts may be deleted automatically during archiving, deleting or routine maintenance of the mobile or computing device.

In relationships, texts, audio messages, and videos are very important. There is often a high risk of forgetting about or losing some of these sentimental items when clearing out a user device, such as a smartphone, or when auto/mass data management (e.g., archiving or deleting) occurs. There becomes extreme value in maintaining these artifacts, especially as users maintain multiple relationships or may be in a mental or elderly state where they may miss out on these.

According to one embodiment, a computer program may determine a sentimentality score that may be attached to each artifact when the sentimentality score is updated during the runtime by analyzing the artifact and user responses while interacting or replying to the artifact. Then the computer program may trigger an archiving policy, such as an automatic back up of the artifact to the cloud, when the sentimentality score reaches a threshold value that was set by the user or program developer.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine a sentimentality score for each of the artifacts based on analyzing the artifact and user reaction while interacting with the artifact and trigger an archiving policy based on determining that the sentimentality score is above a threshold value.

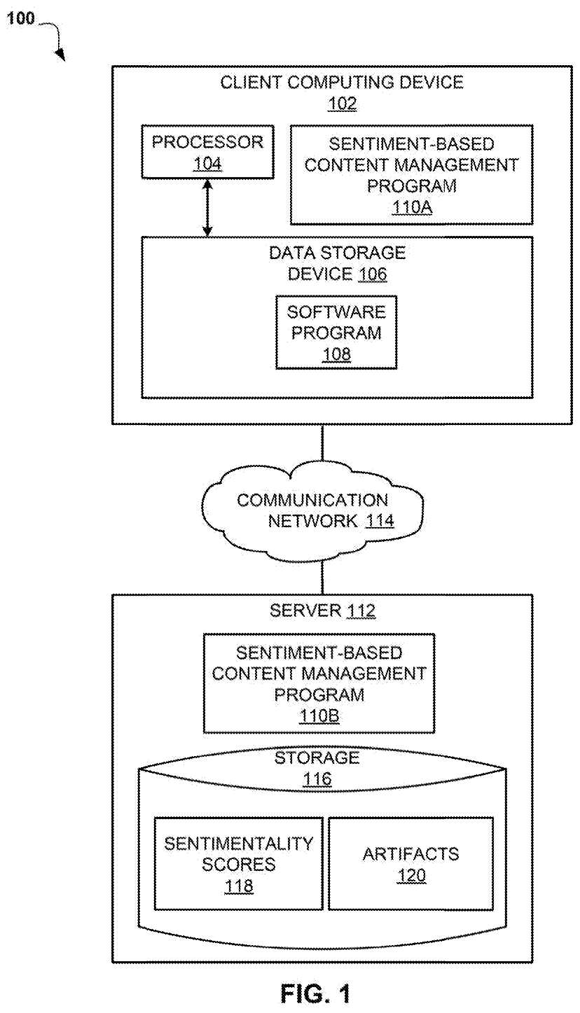

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

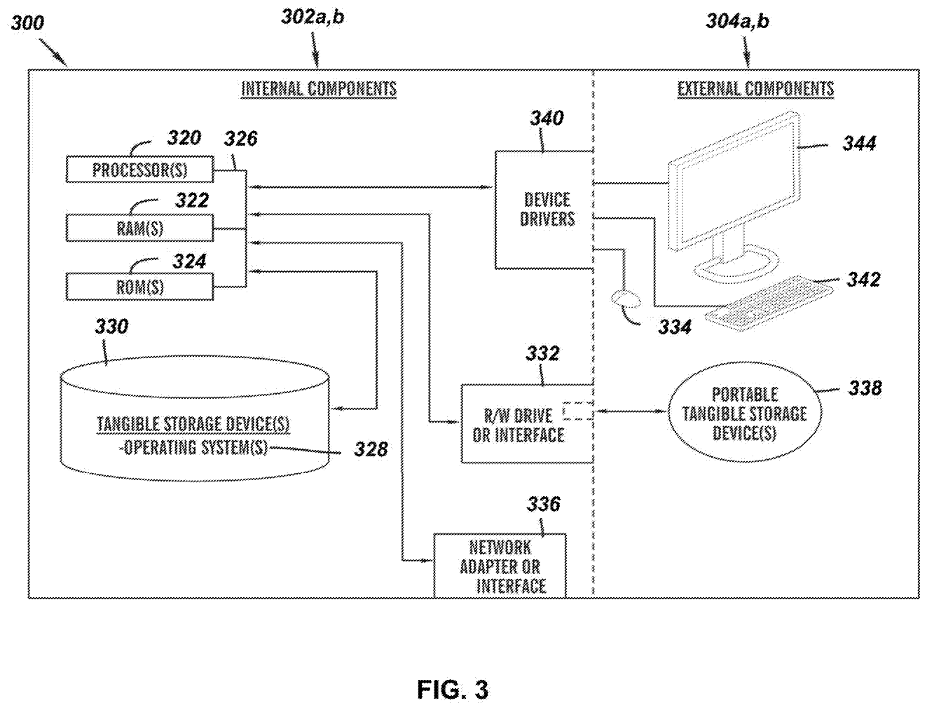

Client computing device 102 may include a processor 104 and a data storage device 106 that is enabled to host and run a software program 108 and a sentiment-based content management program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively. In addition, the client computing device 102 may include internal components 302a and/or external components 304a that are configured to capture and analyze user responses such as a camera and a microphone.

The server computer 112 may be a laptop computer, netbook computer, personal computer (PC), a desktop computer, or any programmable electronic device or any network of programmable electronic devices capable of hosting and running a sentiment-based content management program 110B and a storage 116 and communicating with the client computing device 102 via the communication network 114, in accordance with embodiments of the invention. The storage 116 may store artifacts 120 and one or more sentimentality scores 118 associated with each one of the artifacts. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

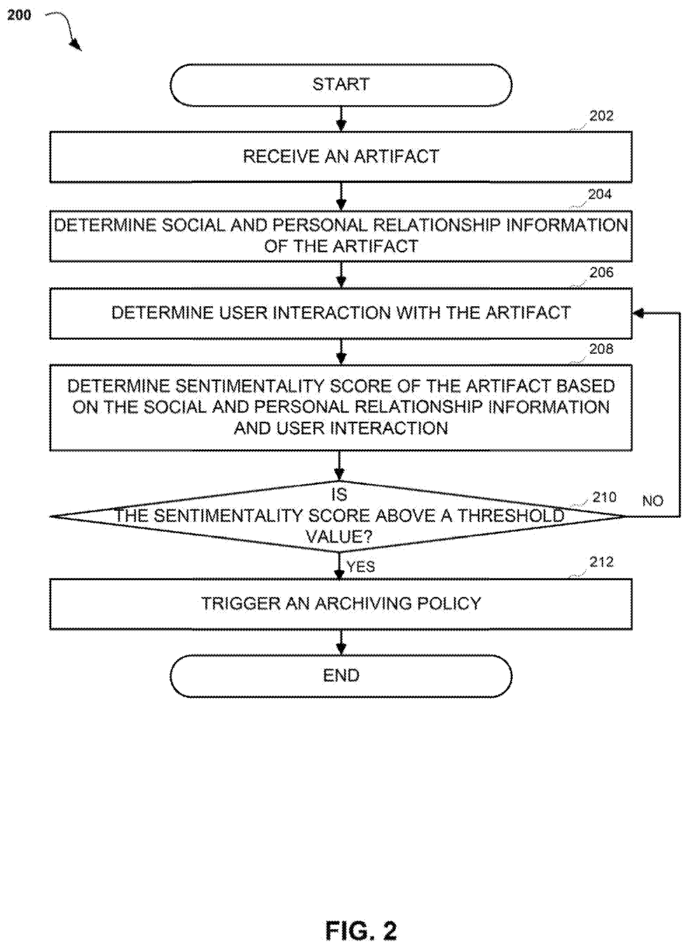

According to the present embodiment, the sentiment-based content management program 110A, 110B may be a program capable of determining a sentimentality score of each artifact by analyzing the artifact and user responses while interacting with the artifact using a trained neural network and trigger an archiving policy based on determining that the sentimentality score is above a threshold value. The sentiment-based content management method is explained in further detail below with respect to FIG. 2.

Referring now to FIG. 2, an operational flowchart illustrating a sentiment-based content management process 200 is depicted according to at least one embodiment. At 202, the sentiment-based content management program 110A, 110B receives an artifact. As previously mentioned, an artifact may be any received user related digital data that includes, but not limited to multimedia (video, photos, graphics, etc.) and communications (audio, text, email, etc). According to an example embodiment, the sentiment-based content management program 110A, 110B may receive any artifact either received or sent by the computing device 102 from any communication channel (i.e., uplink and/or downlink). In one of the embodiments, the sentiment-based content management program 110A, 110B may track all the changes to the artifacts in a permanent and/or persistent memories of the computing device 102 and treat them as received artifacts. For example, a user may receive a text message from his girlfriend stating “So proud of the work you are doing!”, and this message will be treated as a received artifact.

Next, at 204, the sentiment-based content management program 110A, 110B determines social and personal relationship information of the artifact. According to an example embodiment, the sentiment-based content management program 110A, 110B may determine social and personal relationship information by analyzing social network profiles, personal information of the user stored on a computing device and by analyzing user reactions recorded using audio and video capturing devices available on the computing device. According to an example embodiment, the sentiment-based content management program 110A, 110B may first determine the social and personal relationship information of the artifact by analyzing who sent the message by searching social networks and contact databases of the computing device. Then, the sentiment-based content management program 110A, 110B may determine whether the artifact is text, image, video, or audio and perform a type specific sentiment analysis of the artifact and user reaction to that artifact. For example, text artifacts may be analyzed using natural language processing to determine positive, negative or neutral sentiments of the text. Image sentiments may be extracted using visual sentiment prediction model with deep convolutional neural networks that was previously trained. For example, the visual sentiment prediction model with deep convolutional neural networks may return as an output one of six emotional categories both by analyzing the artifact and the reaction of the user to the artifact, such as whether the user shows happiness, sadness, fear, disgust, anger, and/or surprise. Audio artifact and audio reactions of the user while viewing or hearing the artifact may be analyzed by converting the audio to text using automatic speech recognition and then analyzed as text artifacts, as previously described.

Then, at 206, the sentiment-based content management program 110A, 110B determines user interaction with an artifact. According to an example embodiment, the sentiment-based content management program 110A, 110B may collect not just sentiments of the user when reviewing the artifact by analyzing data from peripheral devices such as a camera or a microphone, as previously mentioned, but also count number of times the user reviewed the artifact, sent it to other contacts, posted it on social media platforms. In addition, the sentiment-based content management program 110A, 110B may also record the time stamps representing time when the artifact was accessed, sent or used. According to an example embodiment, the sentiment-based content management program 110A, 110B may convert a user interaction to a user interaction score using a conversion table as, for example, Table 1 below.

TABLE 1

| Action | Score Modification |
|---|---|
| Repeated viewing | +0.05 |
| Sentimental Reaction (crying, smiling, | +0.01 |
| laughing, positive comments) | |
| Time Modifier | Days*(0.001) |

For example, if a message had a previous sentimentality score of 0.765 and a user views the message twice and laughs once while he reviews the message, the calculated sentimentality score may be updated using corresponding numerical values into 0.765+(2*0.005)+0.01=0.785. If a user reviews the same artifact after 30 days the updates sentimentality value may be 0.785+30*0.001=0.815. In addition, the sentimentality score may be changed by a predetermined value if the sender of the artifact is related using data extracted from the contacts database of the computing device or by searching the social networks associated with the user.

Next at 208, the sentiment-based content management program 110A, 110B determines sentimentality score of the artifact based on the social and personal relationship information and user interaction with each of the received artifacts. According to an example embodiment, the sentiment-based content management program 110A, 110B may convert the determined social and personal relationship information coupled with the user interaction information with each of the artifacts into a sentimentality score. According to an example embodiment, each extracted sentiment may be scored numerically from −1 to 1 in a similar way as IBM Watson™ Tone Analyzer (IBM Watson and all IBM Watson-based trademarks and logos are trademarks or registered trademarks of International Business Machines Corporation and/or its affiliates) captures and analyzes voices and extracts sentiments. As previously mentioned, the IBM Watson™ Tone Analyzer service uses neural networks and logics to perform a linguistic analysis and detect emotional and language tones in written text. The IBM Watson™ Tone Analyzer service may analyze tone at both the document and sentence levels. For example, if the artifact is a received text message then the sentiment of the user may be scored using IBM Watson™ Tone Analyzer service available over the network. The scores received from analyzing the artifact and user responses may be added using assigning a special weight to each numerical value representing the score or by multiplying both artifact and user response scores and stored under a sentimentality score value.

Then, at 210, the sentiment-based content management program 110A, 110B determines whether the sentimentality score is above a threshold value. According to an example embodiment, a user may set a threshold value for the sentimentality score value that, if reached, triggers archiving policy for the corresponding artifact. If the sentiment-based content management program 110A, 110B determines that the sentimentality score is above the threshold value (step 210, “YES” branch), the sentiment-based content management program 110A, 110B may continue to step 212 to trigger an archiving policy. If the sentiment-based content management program 110A, 110B determines that the sentimentality score is not above the threshold value (step 212, “NO” branch), the sentiment-based content management program 110A, 110B may return to step 206 to determine user interaction with the artifact. To continue the previous example, if a user set the threshold value to 0.8 the sentiment-based content management program 110A, 110B will trigger the archiving policy because the sentimentality score is 0.815>0.8.

Next at 212, the sentiment-based content management program 110A, 110B triggers an archiving policy. According to an example embodiment, the sentiment-based content management program 110A, 110B may store or treat the artifact differently such as by saving or storing a copy of the artifact in the cloud backup. In another embodiment, the archiving policy may block autodeletion of the artifact or block the user from deleting the artifact without special steps.

It may be appreciated that FIG. 2 provides only an illustration of one implementation and does not imply any limitations with regard to how different embodiments may be implemented. Many modifications to the depicted environments may be made based on design and implementation requirements. For example, if the determined sentimentality score is below a second threshold value, the sentiment-based content management program 110A, 110B may flag the artifact for deletion during automatic maintenance of the computing device to free the storage.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the sentiment-based content management program 110A in the client computing device 102, and the sentiment-based content management program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the cognitive screen protection program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the sentiment-based content management program 110A in the client computing device 102 and the sentiment-based content management program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the sentiment-based content management program 110A in the client computing device 102 and the sentiment-based content management program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

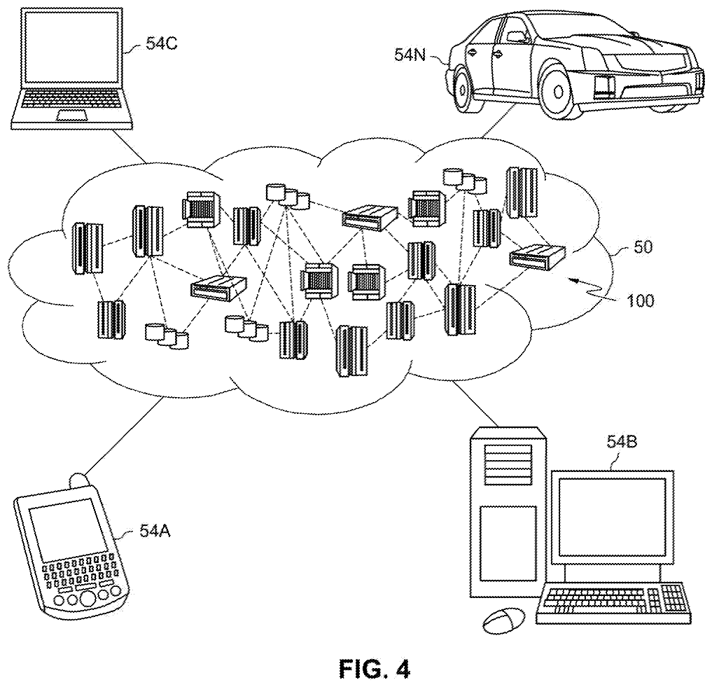

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

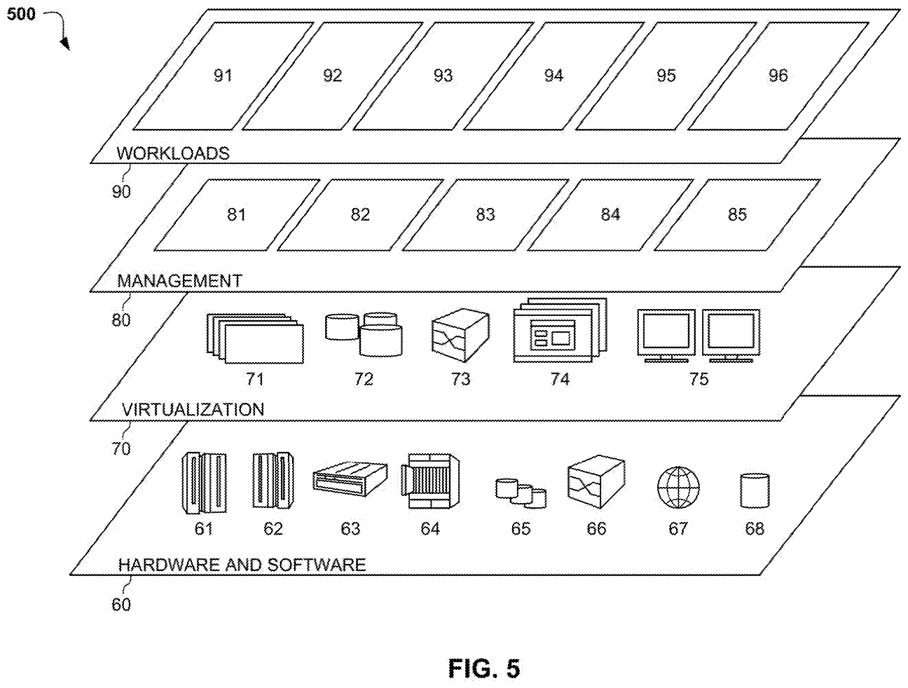

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and sentiment-based content management 96. Sentiment-based content management 96 may relate to analyzing artifacts related to a user and determining a sentimentality score associated with each user. Then, based on the sentimentality score, sentiment-based content management 96 may trigger archiving policies based on comparing sentimentality scores to different predetermined threshold values, where each threshold value determines different archiving policies.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for sentiment-based content management, the method comprising:
receiving an artifact;
determining a relationship of the artifact to a user;
analyzing the artifact to determine sentimental characteristics;
determining user responses to the artifact;
determining a sentimentality score based on the relationship, the sentimental characteristics and the user responses; and
based on determining that the sentimentality score is above a threshold value, triggering an archiving policy.

2. The method of claim 1, wherein the artifact is selected from a group consisting of a text message, a video message, an image, a voice recording, and an email.

3. The method of claim 1, wherein the relationship of the artifact to the user is determined based on a social network profile of the user.

4. The method of claim 1, wherein analyzing the artifact to determine sentimental characteristics is based on a trained deep convolutional neural network.

5. The method of claim 4, wherein determining the responses of the user to the artifact further comprises:
recording the user responses using internal or external components of a computing device; and
analyzing the recorded user responses as artifacts using the trained deep convolutional neural network.

6. The method of claim 1, wherein triggering the archiving policy saves the artifact in a backup cloud.

7. The method of claim 1, wherein determining the sentimentality score based on the relationship, the sentimental characteristics and the user responses further comprises:
converting the relationship, the sentimental characteristics and the user responses into numerical values using conversion table; and
determining the sentimentality score by adding the numerical values multiplied by a specific weight.

8. A computer system for sentiment-based content management, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an artifact;
determining a relationship of the artifact to a user;
analyzing the artifact to determine sentimental characteristics;
determining user responses to the artifact;
determining a sentimentality score based on the relationship, the sentimental characteristics and the user responses; and
based on determining that the sentimentality score is above a threshold value, triggering an archiving policy.

9. The computer system of claim 8, wherein the artifact is selected from a group consisting of a text message, a video message, an image, a voice recording, and an email.

10. The computer system of claim 8, wherein the relationship of the artifact to the user is determined based on a social network profile of the user.

11. The computer system of claim 8, wherein analyzing the artifact to determine sentimental characteristics is based on a trained deep convolutional neural network.

12. The computer system of claim 11, wherein determining the responses of the user to the artifact further comprises:
recording the user responses using internal or external components of a computing device; and
analyzing the recorded user responses as artifacts using the trained deep convolutional neural network.

13. The computer system of claim 8, wherein triggering the archiving policy saves the artifact in a backup cloud.

14. The computer system of claim 8, wherein determining the sentimentality score based on the relationship, the sentimental characteristics and the user responses further comprises:
converting the relationship, the sentimental characteristics and the user responses into numerical values using conversion table; and
determining the sentimentality score by adding the numerical values multiplied by a specific weight.

15. A computer program product for sentiment-based content management, the computer program product comprising:
one or more computer-readable tangible storage medium and program instructions stored on at least one of the one or more tangible storage medium, the program instructions executable by a processor, the program instructions comprising:
program instructions to receive an artifact;
program instructions to determine a relationship of the artifact to a user;
program instructions to analyze the artifact to determine sentimental characteristics;
program instructions to determine user responses to the artifact;
program instructions to determine a sentimentality score based on the relationship, the sentimental characteristics and the user responses; and
based on determining that the sentimentality score is above a threshold value, program instructions to trigger an archiving policy.

16. The computer program product of claim 15, wherein the artifact is selected from a group consisting of a text message, a video message, an image, a voice recording, and an email.

17. The computer program product of claim 15, wherein the relationship of the artifact to the user is determined based on a social network profile of the user.

18. The computer program product of claim 15, wherein program instructions to analyze the artifact to determine sentimental characteristics is based on a trained deep convolutional neural network.

19. The computer program product of claim 18, wherein program instructions to determine the responses of the user to the artifact by program instructions to record the responses using internal or external components of a computing device, and program instructions to analyze the recorded responses as artifacts using the trained deep convolutional neural network.

20. The computer program product of claim 15, wherein program instructions to trigger the archiving policy is program instructions to save the artifact in a backup cloud.
